(19) United States
(12) Patent Application Publication
(10) Pub. No.: US 2016/0017238 A1
(43) Pub. Date: Jan. 21, 2016

(54) Mesoporous Zeolite-Containing Catalysts For The Thermoconversion Of Biomass And For Upgrading Bio-Oils

(71) Applicant: KIOR, INC., Pasadena, TX (US)

(72) Inventors: Dennis Stamires, Dana Point, CA (US); Michael Brady, Studio City, CA (US)

(21) Appl. No.: 14/378,779

(22) PCT Filed: Feb. 15, 2013
(86) PCT No.: PCT/US13/26300

§ 371 Date: Aug. 14, 2014

Related U.S. Application Data
(60) Provisional application No. 61/600,160, filed on Feb. 17, 2012.
(60) Provisional application No. 61/668,573, filed on Jul. 6, 2012.

(51) Int. Cl. C10G 3/00; B01J 29/70; B01J 29/82; B01J 29/40

(52) U.S. Cl. CPC C10G 3/49; B01J 29/40; B01J 29/7007; B01J 29/82

(57) ABSTRACT

Processes for making a catalytic system and catalytic systems for converting solid biomass into fuel of specialty chemical products are described. The catalyst system may comprise a non-zeolitic matrix and an in situ grown zeolite, such as MFI-type zeolite, with a meso-micro hierarchical pore structure. In some embodiments, the non-zeolitic matrix has a meso-macro hierarchical pore structure.

### RELATED APPLICATIONS

This application claims the benefit of and priority to U.S. provisional application Ser. No. 61/668,573, filed Jul. 6, 2012, and U.S. provisional application Ser. No. 61/600,160, filed Feb. 17, 2012, the contents of each of the foregoing applications are hereby incorporated by reference in their entirety.

### FIELD OF THE INVENTION

The invention relates to catalyst compositions with zeolite having a mesoporosity, and more particularly to catalyst compositions for use in the catalytic thermoconversion of solid biomass material into liquid fuels or specialty chemicals, and for upgrading bio-oils.

### BACKGROUND OF THE INVENTION

Biomass, in particular biomass of plant origin, is recognized as an abundant potential source of fuels and specialty chemicals. See, for example, “Energy production from biomass,” by P. McKendry—Bioresource Technology 83 (2002) p 37-46 and “Coordinated development of leading biomass pretreatment technologies” by Wyman et al., Bioresource Technology 96 (2005) 1959-1966. Refined biomass feedstock, such as vegetable oils, starches, and sugars, can be substantially converted to liquid fuels including biodiesel (e.g., methyl or ethyl esters of fatty acids) and ethanol. However, using refined biomass feedstock for fuels and specialty chemicals can divert food sources from animal and human consumption, raising financial and ethical issues.

Alternatively, inedible biomass can be used to produce liquid fuels and specialty chemicals. Examples of inedible biomass include agricultural waste (such as bagasse, straw, corn stover, corn husks, and the like) and specifically grown energy crops (like switch grass and saw grass). Other examples include trees, forestry waste, such as wood chips and saw dust from logging operations, or waste from paper and/or paper mills. In addition, aquacultural sources of biomass, such as algae, are also potential feedstocks for producing fuels and chemicals.

Bio-oils derived from the thermoconversion of biomass and compounds produced by the cracking process of these oil feeds can contain a wide spectrum of molecules of different molecular weights and molecular shape configurations. When biomass materials are subjected to thermal treatment, like in typical pyrolysis processes, the liquids/vapors generated comprise mostly large aromatic and polynuclear aromatic molecules, which are directly released from the biomass as it is thermally decomposed. Additional polynuclear aromatic molecules can be formed from cross-interactions of the nascent molecules at the biomass/vapor interface and in the vapor phase. It is known that long residence times as well as large biomass particles enhance these side reactions and the fuel oil products produced contain larger molecules at a given thermolysis operating reactor temperature. To that effect, the operating parameters need to be optimized for a given kind of biomass material to obtain the maximum oil yield, minimum liquid hydrocarbon oxygen content, and minimum gas and coke yields.

There is a need to develop cost-effective catalyst with optimum accessibility to the catalytic active sites for use in the thermoconversion of biomass to form liquid bio-oil and for the upgrading of bio-oils to contain light molecules and less overall oxygen.

### SUMMARY OF THE INVENTION

Aspects of the invention relate to catalyst systems and methods of making catalyst systems for use in the thermoconversion of biomass, or for the upgrading of bio-oils or bio-oil vapors.

Some aspects of the invention relate to a method for preparing a biomass catalyst system comprising a zeolite phase having a hierarchical microporous-mesoporous structure.

In some embodiments, the catalyst system comprises a zeolite having a hierarchical pore structure ranging from 5 to 20 angstrom pore size, a non-zeolitic matrix with a hierarchical pore structure ranging from about 100 to about 5,000 angstrom pore size, and a binder. In some embodiments, the zeolite has a high silica to aluminum ratio. In some embodiments, the zeolite can be MFI, beta zeolite or mixtures thereof. In some embodiments, the zeolite further comprises a Faujasite-type zeolite. In some embodiments, the zeolite can be MFI or beta-zeolite and further comprises NaY zeolite, REUSY zeolite, USY zeolite, DAY zeolite or a combination thereof. In some embodiments, the zeolite is a hydrothermally treated zeolite. In some embodiments, the zeolite is a dealuminated zeolite or a desilicated zeolite. In some embodiments, the zeolite is ion-exchanged. In some embodiments, the zeolite and/or the matrix can be phosphated.

In some embodiments, the matrix comprises a clay or clay mixture. In some embodiments, the matrix comprises silica, alumina, a silica-alumina, transitional metal oxide or combination thereof. The transitional metal oxide can be titanium dioxide or zirconium dioxide. In some embodiments, the matrix comprises a synthetic clay, such as a layered double hydroxide.

In some embodiments, the matrix has a hierarchical pore structure ranging from about 100 to about 1,000 angstrom, or from about 400 to about 6,000 angstrom or higher.

In some embodiments, the binder is a silica, a phosphate, or ammonium polysilicate.

In some embodiments, the catalyst system can be used to convert biomass or upgrade bio-oils or bio-oil vapors.

Some aspects of the invention relate to a method for preparing a biomass catalyst system, the method comprising (a) modifying a zeolite to form a zeolite having a hierarchical microporous-mesoporous structure; (b) preparing a slurry precursor mixture by mixing the modified zeolite, a non-zeolitic inorganic matrix, a binder, a combustible organic compound in water; (c) shaping the mixture to form shaped bodies; and (d) thermally treating the shaped bodies to remove the combustible organic compound, wherein the biomass catalyst system has a matrix phase having a hierarchical mesoporous-macroporous structure and a zeolite phase having a microporous-mesoporous hierarchical structure.

In some embodiments, the step of modifying the zeolite comprises (i) thermally treating the zeolite to form a non-framework alumina; and (ii) treating the thermally treated zeolite with a mild acid to remove the non-framework alumina. In some embodiments, the acid can be an organic acid, such as is nitric acid, hydrochloric acid, sulfuric acid or mixture thereof, or an inorganic acid, such as acetic acid, oxalic acid, citric acid or mixture thereof. In some embodiments, the thermally treated zeolite can be treated with a mild acid in combination with a chelating agent.

In some embodiments, the step of modifying comprises (i) treating the zeolite with a base to remove part of the silica framework. In some embodiments, the base is sodium hydroxide, sodium carbonate, sodium bicarbonate, sodium aluminate or a mixture thereof. In some embodiments, the step of modifying further comprises (ii) treating the base treated zeolite with a mild acid.

In some embodiments, the method further comprises treating the shaped bodies with a mild acid solution to dealuminate the zeolite before step (d). In some embodiments, the method further comprises preparing a slurry of zeolite seeding material in presence of a pore regulating agent and thermally treating the slurry to form the zeolite prior to step (a).

In some embodiments, the pore regulating agent is combustible and the step of thermally treating removes the combustible pore regulating agent. For example, the pore regulating agent is carbon black or a combustible organic polymer. In some embodiments, the pore regulating agent is combustible and is the same combustible organic compound of step (b). In some embodiments, the pore regulating agent is a soluble organic polymer.

In some embodiments, the zeolite is MFI, beta zeolite, dealuminated zeolite, desilicated zeolite or mixture thereof. In some embodiments, the zeolite and/or the matrix can be phosphated.

In some embodiments, the zeolite having a hierarchical microporous-mesoporous structure of step (a) is mixed with a zeolite of the Faujasite-type zeolite. In some embodiments, the zeolite having a hierarchical microporous-mesoporous structure of step (a) is mixed with a Zeolite Y, a USY zeolite, a REUSY zeolite, a DAY zeolite or NaY zeolite combinations thereof.

In some embodiments, the non-zeolitic matrix is a clay or clay mixture.

In some embodiments, the step of thermally treating comprises subjecting the shaped bodies to calcination or steaming and heating the thermally treated shaped bodies in presence of a mild acid to remove the non-framework alumina. In some embodiments, the step of thermally treating comprises subjecting the shaped bodies to calcination or steaming in presence of weak base to desilicate the zeolite. In some embodiments, the step of thermally treating comprises subjecting the shaped bodies to calcination or steaming and treating the thermally treated shaped bodies in presence of a weak base to desilicate the zeolite. In some embodiments, the weak base is sodium carbonate, ammonium hydroxide or a combination thereof.

Some aspects of the invention relate to a composition for the conversion of biomass comprising a catalyst system comprising (a) a zeolite having a high silica to aluminum ratio and a hierarchical pore structure with pores having a size ranging from about 5 to 20 angstrom, a non-zeolitic matrix with a macroporosity from about 100 to about 5,000 angstrom pore size range, and a binder and (b) a feedstock having a carbon ¹⁴C isotope content of about 107 pMC. In some embodiments, the zeolite is MFI, beta zeolite or mixtures thereof. In some embodiments, the matrix comprises silica, alumina, silica-alumina, transitional metal oxide or combination thereof. In some embodiments, the feedstock is a particulated biomass, or is a product derived from pyrolysis of biomass, such as a bio-oil vapor or a bio-oil.

In other aspects of the invention, the method comprises (a) preparing a slurry precursor mixture comprising a clay material and optionally an inorganic binder, (b) shaping up the mixture to form shaped bodies, for example by spray drying the slurry, (c) preparing an aqueous slurry comprising the shaped bodies in presence of a zeolite seeding material, (d) thermally treating the aqueous slurry to form composite shaped bodies comprising in situ crystallized zeolite, and (e) chemically treating the composite shaped bodies. In some embodiments, the aqueous slurry is prepared in presence of a silica source or an alumina source or a silica source and an alumina source. In some embodiments, the method further comprises impregnating the chemically treated shaped bodies with a phosphorous compound thereby forming composite shaped bodies having phosphated in situ crystallized zeolites and optionally calcining the phosphated composite shaped bodies.

In some embodiments, the slurry is thermally treated under autogenous pressure. In some embodiments, the composite shaped bodies can be treated at 80° C. or below 100° C. In some embodiments, the composite shaped bodies can be treated by subjecting the composite shaped bodies to an alkaline treatment, a mild acid treatment or an alkaline and a mild acid treatment. The alkaline treated shaped bodies can optionally be subjected to calcination and to a mild acid treatment. In some embodiments, the alkaline treatment can remove at least part of the lattice silicon and the mild acid treatment can remove at least part of the lattice aluminum. In some embodiments, the alkaline treatment comprises adding a solution comprising sodium carbonate, sodium hydroxide or mixture thereof. In some embodiments, the acid treatment comprises adding a mild acid solution. The acid can be an organic or inorganic acid. For example, the organic acid can be acetic acid, oxalic acid, citric acid or mixtures thereof. The inorganic acid can be nitric acid, hydrochloric acid, sulfuric acid or mixtures thereof.

In some embodiments, the method further comprises subjecting the composite shaped bodies to calcination or steaming after the chemical treatment step.

In some embodiments, the method further comprises subjecting the composite shaped bodies to ion-exchange. For example, the composite shaped bodies can be ion-exchanged with metal ions, such as metal ions in a monovalent, a divalent or a trivalent form

In some embodiments, the clay material comprises a clay mixture. For example, the clay material comprises a mixture of kaolin clay and calcined kaolin clay. In some embodiments, the zeolite can be a MFI-type zeolite, NaY zeolite or a beta-zeolite. In some embodiments, the binder can be silica, alumina, silica alumina or phosphate.

In some embodiments, the method comprises mixing the catalyst system with biomass particles.

Some aspects of the invention relate to a catalyst system having a clay matrix and in situ crystallized zeolite having a hierarchical pore structure ranging from 20 to 1,000 Angstrom pore size. In some embodiments, the zeolite is a MFI-type zeolite, a NaY zeolite or a beta-zeolite. In some embodiments, the catalyst system can be used in the catalytic thermolysis of biomass or in upgrading of bio-oil.

Aspects of the invention relate to compositions comprising a catalyst system comprising a clay matrix and in situ crystallized zeolite having a hierarchical pore structure ranging from 20 to 1,000 Angstrom pore size, and a feedstock having a carbon ¹⁴C isotope content of about 107 pMC.

In some embodiments, the zeolite can be a dealuminated zeolite, a desilicated zeolite or dealuminated desilicated zeolite. The zeolite can be phosphated. The zeolite can be ion-exchanged.

In some embodiments, the clay matrix comprises a clay, a modified clay, a clay mixture, a modified clay mixture or combination thereof. For example, the clay can be kaolin or a mixture of kaolin and calcined kaolin. In some embodiments, the catalyst system comprises a binder, such as silica, alumina, silica alumina or phosphate.

In some embodiments, the feedstock is a particulated biomass, or is a product derived from pyrolysis of biomass. For example, the feedstock can be a bio-oil vapor or a bio-oil.

Some aspects of the invention relate to methods for method for preparing a catalyst system. In some embodiments, the method comprises (a) preparing a slurry precursor mixture comprising a clay material and a pore regulating agent, (b) shaping up the mixture to form shaped bodies, (c) removing the pore regulating agent to form porous shaped bodies, (d) preparing an aqueous slurry comprising the porous shaped bodies in presence of a zeolite seeding material, and optionally an alumina source, a silica source or an alumina source and a silica source, (e) thermally treating the aqueous slurry to form composite shaped bodies comprising zeolite, and (f) chemically treating the composite shaped bodies. In some embodiments, the catalyst system comprises matrix phase having a hierarchical mesoporous-macroporous structure and a zeolite phase having a hierarchical microporous-mesoporous structure.

In some embodiments, the method further comprises adding an inorganic binder, an additive, a phosphorous compounds or mixtures thereof in the slurry precursor mixture.

In some embodiments, the pore regulating agent is a combustible organic material. The pore regulating agent, in some embodiments, can be removed by calcination.

In some embodiments, the method comprises leaching the porous shaped bodies. For example, the porous shaped bodies can be treated with an acid to remove at least part of the alumina content. In other embodiments, the porous shaped bodies can be treated with a base to remove at least part of the silica content. Yet in other embodiments, the porous shaped bodies can be treated with an acid to remove at least part of the alumina content and with a base to remove at least part of the silica content.

In some embodiments, the combustible organic material can be selected from the group of compounds containing cellulosic type, starch, sawdust, corn flour, wood flour, shortgum, gums, corn stover, sugar bagasse, plastic, resin, rubber, carbohydrates, organic polymers, carbon black or mixtures thereof. For example, the carbohydrate can be a cellulosic carbohydrate. In some embodiments, the combustible organic material is a fine organic particulate. In some embodiments, the pore regulating agent is a soluble material.

In some embodiments the zeolite is a MFI-type zeolite, NaY zeolite or a beta-zeolite.

In some embodiments, the chemical treatment comprises subjecting the composite shaped bodies to an alkaline treatment, an acid treatment or an alkaline and an acid treatment. In some embodiments, the alkaline treatment removes at least part of lattice silicon and the acid treatment removes at least part of lattice aluminum. In some embodiments, the alkaline treatment comprises adding a solution comprising sodium carbonate, sodium hydroxide or mixture thereof.

In some embodiments, the clay matrix comprises a clay, a modified clay, a clay mixture, a modified clay mixture or combination thereof. For example, the clay can be kaolin or a mixture of kaolin and calcined kaolin. In some embodiments, the clay material comprises modified kaolinite, halloysite, diatomite or mixture thereof.

In some embodiments, the catalyst system comprises a binder, such as silica, alumina, silica alumina or phosphate.

In some embodiments, the method further comprises subjecting the composite shaped bodies to calcination or steaming prior the chemical treatment step or after the chemical treatment step.

In some embodiments, the method further comprises chemically treating the shaped bodies prior to step of preparing an aqueous slurry comprising the porous shaped bodies in presence of the zeolite seeding material, and optionally the alumina source, the silica source or the alumina and the silica source.

In some embodiments, the catalyst system is mixed with biomass particles, with biomass derived vapors or with bio-oils.

Some aspects of the invention relate to a catalyst system comprising in situ crystallized zeolites having a hierarchical pore structure ranging from 20 to 1,000 Angstrom pore size, a non-zeolitic matrix having a hierarchical pore structure ranging from 50 to 5,000 Angstrom pore size.

In some embodiments, the zeolite is a MFI-type zeolite, a beta-zeolite or mixture thereof. The zeolite can be a hydrothermally treated zeolite. The zeolite can be a dealuminated zeolite, a desilicated zeolite or dealuminated desilicated zeolite. The zeolite can be phosphated. In some embodiments, the matrix is phosphated or the zeolite and the matrix are phosphated.

In some embodiments, the clay matrix comprises a clay, a modified clay, a clay mixture, a modified clay mixture or combination thereof. For example, the clay can be kaolin or a mixture of kaolin and calcined kaolin. In some embodiments, the clay material comprises modified kaolinite, delaminated kaolin, leached delaminated kaolin, halloysite, diatomite or mixture thereof.

In some embodiments, the catalyst system comprises a binder, such as silica, alumina, silica alumina or phosphate.

Some aspects of the invention relate to compositions comprising in situ crystallized zeolites having a hierarchical pore structure ranging from 20 to 1,000 Angstrom pore size into a clay matrix having a hierarchical pore structure ranging from about 50 to about 5,000 angstrom and a feedstock having a carbon ¹⁴C isotope content of about 107 pMC.

In some embodiments, the zeolite is a MFI-type zeolite, a NaY zeolite, a beta-zeolite or mixture thereof. In some embodiments, the clay is kaolin clay, a modified kaolin clay or mixture thereof. In some embodiments, the feedstock is a particulated biomass, or is a product derived from pyrolysis of biomass. For example the feedstock is a bio-oil vapor or a bio-oil.

Some aspects of the invention relate to compositions comprising a catalyst system comprising in situ crystallized zeolites having a hierarchical pore structure ranging from 20 to 1,000 Angstrom pore size into a clay matrix having a hierarchical pore structure ranging from about 50 to about 5,000 angstrom and an oil feedstock. In some embodiments, the oil is a bio-oil, or a heavy oil feedstock.

### DETAILED DESCRIPTION OF THE INVENTION

Most of the known fluid catalytic cracking (FCC) catalysts have been designed to catalytically crack light petroleum feeds, or Vacuum Gas Oil (VGO) that contain light hydrocarbon molecules, or small amount of polynuclear aromatic molecules and in general small amount of bulky molecular components. A few FCC catalysts have been designed and used to crack heavy resid feeds. The discovery of zeolitic FCC catalysts and their use in oil refineries made it possible to substantially reduce the contact times between the oil feed and catalyst particles, and improve product yield and product selectivity. However, when using short contact times and heavier feedstocks containing larger size molecules, the availability and accessibility of the catalytic active sites within the zeolite crystals can be reduced. For example, when using heavier feedstocks such as heavy oils or resids as feeds to catalytic cracking systems operating with short residence times, skin-layers of contaminant metals can form on the outside surface of the catalyst particles causing the blocking of the pore openings and the pathways that lead to the zeolite particles (referred herein as “Matrix Accessibility Limitations” or “MAL”). In addition, similar limitations apply to the function of the zeolite crystals when used for processing heavy oils with short contact times (referred herein as “Zeolite Accessibility Limitations” or “ZAL”). These limitations can include diffusional and mass transport limitations since the reactant needs first to be transported through the bulk of the catalyst matrix to the zeolite crystal and then, through the channels of the zeolite crystal to the catalytic active site locations within the three dimensional structure of the zeolite crystal.

In addition, it has been well established over the years since FCC catalysts have been in use in oil refineries, that microspheroidal catalyst particles with weak mechanical strength can break down during their circulation in the FCC Unit forming microfine particles that cause problems in the overall mechanical operation of the FCC Unit, as well as excessive catalyst losses that increase the cost of the operation.

It should therefore be appreciated that for the catalytic thermoconversion to be efficient, the catalyst particles should have a suitable mechanical strength, high attrition resistance, as well as have a reasonable resistance to chemical acidic attacks, especially when exposed in a high temperature environment. Such properties allow the use of the catalyst particles in the reactor and regenerator for longer period of time while maintaining the activity and selectivity of the catalyst particles.

Accordingly, aspects of the invention relate to catalyst particles having an improved porosity and attrition resistance for the thermoconversion of biomass and upgrading of bio-oils.

In some aspects of the invention, the catalyst particles to be used in the catalytic thermoconversion of biomass can be designed to be at least as attrition resistant as the regular FCC catalysts used in the FCC for the crude oil cracking Such properties are important since the crude, raw biomass usually contains inorganic particular foreign materials, such as sand, that can attrite the catalyst particles.

In the catalytic thermolysis of biomass, fresh catalyst particles or catalyst particles coming from the catalyst regenerator can be introduced in the reactor chamber to be brought in contact with the particular biomass in the mixing chamber of the reactor (rostrum). A stream of lift gas can be introduced in the mixing chamber to create a fluidized bed comprising the catalyst particles and the biomass particles. Generally, during thermolysis, the catalyst particles continuously collide with the walls of the mixing chamber and reactor (e.g. riser) pipe. In addition, the catalysts can enter in contact with water vapor, light gases and organic solids produced during the thermo-conversion of biomass in a high temperature environment. Therefore, the catalyst particles, besides being mechanically impacted, can also be exposed to a reactive and detrimental chemical environment. Under high temperature conditions, the chemicals can react with the surface of the catalyst particles. For example, in the catalytic thermoconversion of biomass, the catalyst particles can be exposed to steam and organic acids produced by the thermolysis of biomass at temperatures in the range of 500 to 600° C., which can chemically react with the surface of the catalyst particles. Such environment can result in the weakening of the physical strength of the catalyst particles, and in high attrition losses and/or fracture of the catalyst particles, producing microfine particles.

In some aspects of the invention, the catalyst particles for use in the catalytic thermoconversion of the biomass are designed to have minimal diffusional restrictions and increased accessibility of the catalytic zeolite active sites. When using matrix-zeolite composite as catalyst particles, both reactants and product molecules have to cross-transverse and diffuse in and out the matrix and the zeolite phases of the matrix-zeolite composite. It ensues that it is advantageous to minimize diffusion restrictions and increase accessibility of the catalytic zeolite active sites to obtain efficient and selective cracking conversion process, and minimize undesirable side reactions such as coke and gas formation. Other aspects of the invention relate to methods for increasing the accessibility of catalytically active acid sites within the zeolite crystals, and increasing the mass transport and diffusion rates of reactant and reaction product molecules in and out of the zeolite crystals. In some embodiments, the methods comprise designing shaped-body catalyst particles, such as microspheres or extrudates, having matching large pore structures, to allow the catalyst particles to utilize fully the increased accessibility of the active sites within the zeolite particle.

One skilled in the art would appreciate that for the cracking reaction to be efficient and selective, the matrix phase should have sufficient porosity, with pores having suitable sizes and channels having suitable width, so that the reactant molecules can be transported with minimum diffusional constrains.

It should be noted that since the major portion of catalytic active sites (also referred herein as acid sites) is located in the interior bulk of the zeolite crystals, reactants, reaction product molecules and intermediates need to travel in and out the zeolite crystals in order to react with the active sites. In particular, for large reactant molecules, small channels (such as 10 angstrom wide) and small cavities (such as 20 angstrom wide) impose diffusion limitations that result in undesirable side reactions, high back pressures within the catalyst shaped particles, restricted mass transfer and accelerated catalyst deactivation due to excessive coke formation. It ensues that the zeolite of the catalyst particles should have sufficiently large pore openings and channels widths to allow the reactant molecules to reach the catalytic active sites and to allow the reaction products to diffuse out of the zeolite crystals phase and out of the matrix phase into the vapor/gas phase of the catalytic cracking reactor. Accordingly, the catalyst particle, in some embodiments, is designed to have a mesoporosity such as the accessibility of the catalytic cracking sites located into the bulk of the zeolite crystals is optimized to allow the reactant molecules to diffuse, first, through the matrix phase and then through the zeolite crystal phase to reach and react with the catalytic acid sites located in the interior of the zeolite crystals. Once the reactant molecules enter the catalyst particle, they are transformed into a different molecular form and diffuse out of the catalyst particles in the opposite direction, first through the zeolitic phase then through the matrix phase.

It should be noted that the catalysts usually contain alumina gels, silica gels, silica-alumina, clays compounded together to form microspheres, with high bulk densities and small pore size distributions, that can limit accessibility to zeolite crystals within the matrix. The lack of large pores and channels within the matrix can cause diffusion limitations for the inbound and outbound molecules, allowing cross-reaction between these molecules. Coke or heavy polynuclear molecules resulting from over-cracking can get deposited within the matrix and block or cover the feeder-pores of zeolite crystals, thus reducing the effectiveness of the accessibility and the extra porosity created in the zeolite crystals.

In some aspects of the invention, methods for modifying the matrix phase to increase the meso/macro porosity within the matrix phase are disclosed. This allows the mesoporous zeolite to function more effectively without impeding but preferably enhancing, the mass transport of the reactants and reaction products from the gas phase (in the reactor) through the matrix and the zeolite phases to the catalytic acid sites and back, diffusing through the two solid phases to exit into the gas phase. In some embodiments, the catalyst shaped bodies, such as microspheres or extrudates, are designed to have matching large pore structures to fully utilize the increased accessibility of active sites within the zeolite particle.

In some embodiments, the zeolite particles can be designed to have a tailored mesoporosity to facilitate the diffusion and mass transport of the reactant molecules from outside the zeolite crystal to the interior located active sites, and allow the reaction products to get out of the zeolite crystals and travel through the matrix to escape into the vapor phase.

The catalyst particles, in some embodiments, are designed such as the accessibility of the catalytic cracking sites (located into the bulk of the zeolite crystals) is optimized to allow the reactant molecules to diffuse, first, through the matrix phase and then through the zeolite crystal phase to reach and react with the catalytic acid sites located in the interior of the zeolite crystals. Once the reactant molecules enter the catalyst particle, the reactant molecules can be transformed into a different molecular form and diffuse out of the catalyst particles in the opposite direction, first through the zeolitic phase then through the matrix phase. One skilled in the art will appreciate that a high matrix accessibility to the zeolite crystallites can increase the mass transport rates of the reactant molecules to the interior of the catalyst particle as well as increase the reverse mass transport of the reaction products from the zeolite crystallites located in the interior of the catalyst particle to the outside vapor phase in the reactor chamber.

In some embodiments, the catalyst particles have a bulk matrix active site accessibility designed to allow the catalytic process to proceed efficiently without mass transport diffusional limitations. In particular, for the biomass cracking reaction to be efficient and selective, the matrix phase should have sufficient porosity, with pores having suitable sizes and channels having suitable width, so that the reactant molecules can be transported with minimum diffusional constrains. Thus, in various embodiments, catalysts with matrixes with meso/macro porosity to allow for bulk catalytic and site accessibility are provided.

In some embodiments, catalysts with high bulk catalytic and site accessibility and having zeolite crystals with increased bulk interior site accessibility are provided. Some embodiments relate to catalyst particles combining MFI zeolites having an intracrystalline micro/mesoporosity with specific matrix composition having suitable meso/macro porosity. In some embodiments, the catalyst particles comprise a matrix/substrate phase, and zeolite crystals phase having a substantial mesoporosity to allow efficient mass transport into and out of the crystals, travel for the reactant molecules, and the formed reaction products to cross-diffuse and travel out of the catalyst particles.

In some embodiments, catalyst particles with an internal structural architecture comprising a matrix having a hierarchical pore structure and a zeolite having a hierarchical pore structure arranged so that the overall matrix-zeolite porosity represents a continuous pore-connectivity are provided. In a simplified representation of the structure of the catalyst particle, the matrix can be represented as a honey-comb macroporous structure with nested mesoporous zeolite crystallites, the matrix-zeolite composite particle having a continuous multi-scale functional porosity.

In some embodiments, considering the mass transport/diffusional limitations and the accessibility of the active acid sites, it is desirable to have the pathways and channels of the matrix phase aligned in a concentric-like array with the channels and pore openings of the zeolite phase. It can be envisioned that the pathways of the matrix and zeolite form aligned conduits in a concentric continuum, wherein the matrix conduits have larger pore openings and channels, leading and connecting to the zeolite pore openings, in a fashion that allows the molecules to cross-diffuse with the minimum steric-resistance and with maximum accessibility to the catalytic

In some embodiments, the catalyst particles for use in the catalytic thermolysis of biomass or in the catalytic upgrading of bio-oils can have the following characteristics: (1) suitable attrition resistance to withstand collisional impacts with the metal surfaces, with the biomass particles, and with ash particles; (2) suitable resistance to chemical reactions involving the hot corrosive vapors and gases in the reactor and stripper environments; (3) zeolite crystals having suitable mesoporosity to allow the reactant molecules to reach the catalytic acid sites located in the interior of the crystals to react, and then also allow the products of the reaction to diffuse back out of the zeolite crystals and travel through the matrix phase to exit the catalyst particles and enter the reactor vapor phase. In some embodiments, the catalyst particles further comprise a matrix or substrate phase designed or tailored-build to have a meso/macroporosity throughout the phase that provides sufficient accessibility to the zeolite crystallites embedded into the matrix.

### I. Zeolite Phase

Catalyst compositions according to some aspects of the invention comprise microspherical particles having zeolite particles. Zeolites are crystalline aluminosilicates built from TO4 units (T being Si, and/or Al) that are arranged in such a manner that intra crystalline pores, channels and cavities are created with molecular dimensions. In some embodiments, the zeolite can be a mordernite inverted framework type zeolite (MFI). In some embodiments, the zeolite can be a ZSM-5, H-ZSM, Na-ZSM, beta-zeolite or mixture thereof. In some embodiments, the zeolite can be a mixture of MFI and Faujasite-type zeolite. In some embodiments, the zeolite can be MFI or beta-zeolite and further comprises NaY zeolite, REUSY zeolite, USY zeolite, DAY zeolite or a combination thereof.

Generally, the pores of non-modified MFI-type zeolites have diameters less than 20 Angstrom (Å), for example, in the range of 4 to 12 Angstrom and are classified as being micropores based on the IUPAC classification of porous materials. The sizes and shapes of the micropores are determined by the specific crystallographic structure of the zeolites, providing the molecular sieve effects which can be unique to different crystal architectures of the individual zeolites. These unique architectural micropore zeolite crystal structures allow for shape-selective molecular absorption and catalysis, based on molecular exclusion (or hindered diffusion) and inclusion, of the reactants and products. The inclusion/exclusion processes which determine the reactant molecules that can enter the zeolite pore structure to react, as well as the reactive pathway, are governed by the sterically confined reaction space surrounding the catalytically active acid sites, most of which are located within the micropores.

Aspects of the invention relate to methods for creating intracrystalline mesoporosity in the zeolite crystals while controlling and maintaining the microporosity as well as the crystallographic structure of the zeolite. In particular, aspects of the invention relate to methods for introducing mesoporosity in catalysts comprising small pores zeolites to optimize the accessibility and density of the active acid site. The creation of a mesopore structure in the zeolite crystals can provide pathways that increase the mass transfer and diffusion of the reactant and product molecules, while the microporosity provides the major portion of the acid sites.

In some embodiments, the catalyst particles have a dual hierarchical pore structure with a major portion of the pores in the mesopore range that extends above the micro-pore region (i.e. above about 20 angstrom) up to about 50 angstrom. The creation of mesoporosity in the small pores MFI-type zeolites can allow for fast mass transfer to and from the interior of the zeolite crystallites and through the catalyst particles, exiting into a gas/vapor phase in the fluid bio reactor. In addition, the creation of mesoporosity can result in an increase of the catalytic activity of the zeolite as well as product yield, selectivity and regenerability of the catalyst.

In some aspects of the invention, the catalyst compositions comprise microspherical particles having pre-crystallized zeolite particles. In some embodiments, zeolites can be grown in presence of a pore regulating agent such as a combustible or soluble pore regulating agent. The combustible pore regulating agent can be carbon black or a combustible organic polymer, such as sugar or starch. The zeolite can then be compounded with the matrix and a binder, spray-dried to form shaped bodies and subjected to calcination to remove the combustible pore regulating agent

In other aspects of the invention the zeolites are formed by in situ zeolitization. One of skill in the art will appreciate that the in situ growth of zeolites on pre-formed clay-based microspheres provides some advantages as compared to the traditional processes in which pre-crystallized zeolite particles are incorporated into a slurry, together with binder and other matrix components, such as clay, and in which the slurry is spray dried to form the microspheres containing the embedded zeolite crystals.

The in situ zeolitization process can have the advantage to result in the formation of microsphere particles that are attrition resistant, have a high concentration of zeolites and cheaper to produce. In addition, in situ zeolitization can allow for a considerable number of zeolite crystallites to grow on the surface of the microspheres, allowing the reactant oil-feed to have direct access to the catalytic active sites (e.g. through feeder pores), with minimum diffusional restrictions.

However, it should be appreciated that although the particles having in situ grown zeolites can be denser and have improved attrition properties, they can exhibit the same pore-size molecular diffusional limitations as catalyst particles formed by incorporating in the slurry pre-crystallized zeolites together with the other catalyst components followed by spray drying to form catalyst microspheres.

Accordingly, in some aspect of the invention, compositions and methods to form catalyst microspheres having a zeolite phase in situ grown on the microspheres, and modified to minimize molecular absorption/desorption diffusional limitations are provided. In some embodiments, methods to form catalyst particles comprising MFI zeolites modified to have a hierarchical pore structures are provided.

In some embodiments, the in situ grown zeolites have a hierarchical pore structure comprising (1) the inherent micropore crystal structure (also referred herein as parent or non-modified pore structure), (2) the created extra intra-crystalline mesopore structure, formed by, for example, chemical treatments disclosed herein (also referred herein as modified pore structure), and (3) the inter-crystalline macropore structure which is created by (a) different size and shapes of the individual zeolite crystals and (b) the packing and density of the individual zeolite crystals in the composite material.

### Preparation of MFI Zeolites Exhibiting Hierarchical Mesoporous Structures

It should be noted that in spite of their wide spread commercial use as catalysts, the MFI-zeolites can exhibit certain limitations due to the small size of the channels, which are in general less than 1 nm (10 Å), and the cavities sizes, which are in general less than 2 nm (20 Å).

Since most of the catalytic active sites (also referred herein as acid sites) are located in the interior bulk of the crystallites, reactant and reaction product molecules and intermediates need to travel in and out of the crystallites in order to react with the active sites. In particular, for large reactant molecules, the small channels (such as 10 angstrom wide) and small cavities (such as 20 angstrom wide) impose diffusion limitations that result in undesirable side reactions such as high back pressures within the catalyst shaped particles, restricted mass transfer and accelerated catalyst deactivation due primarily to excessive coking.

In various embodiments, methods for generating zeolite crystals with mesoporosity are provided. In some embodiments, the methods comprise demetalation of the zeolites. For example, the methods can comprise base (alkaline) crystal leaching to remove lattice silicon and/or acid leaching to remove lattice aluminum from the in situ grown zeolite crystal.

In some embodiments, MFI-type zeolites such as ZSM and beta-zeolites, having a high silica alumina ratio (SAR) and few aluminum acid sites can be synthesized. For example, the SAR can be in the range of 25 to 100. Since the number of aluminum acid sites in the MFI-type zeolites is limited, it may be desirable, from a catalytic point of view, to keep most of the available catalytic acid sites in the crystal intact and active. However, MFI-type zeolites can lose some alumina acid sites during thermal and hydrothermal treatments and form a small amount of non-framework alumina (also referred herein as NFA). In some embodiments, MFI-type zeolites can be subjected to controlled and mild acid leaching to remove non-framework alumina. Such mild/controlled acid treatment can have a smaller effect on the zeolite crystal bulk porosity when compared to the removal of silica from the framework by desilication using inorganic bases.

In various embodiments, the small-pore of the MFI-type zeolites can be subjected to modifications to form modified forms of zeolites having an increased bulk acid site accessibility, a mesoporosity, as well as an optimized bulk density of the acid sites in the zeolite crystals. In some embodiments, methods of making and compositions comprising MFI-type zeolites having a dual hierarchical pores structure, with a major portion of the pores in the mesopore ranges that extends above the micropore region up to 100 Angstrom and preferably up to 50 Angstrom are provided. Such zeolites can allow for fast mass transfer to and from the interior of the zeolite crystallites and through the catalyst particles, and for facilitation of the exit of the products into to the gas/vapor phase in the fluid bed reactor.

It is known that zeolites grown with small crystallite sizes exhibit a lesser hydrothermal stability, lose crystallinity faster during catalyst regeneration and are more difficult to filter after the crystallization step of the mother liquor.

Accordingly, in some embodiments, to alleviate mass transfer limitations, zeolites can be grown with small crystallites. Yet in other embodiments, to alleviate mass transfer limitations, zeolites can be grown with larger pores, or large pores can be built into the zeolites particles. In some embodiments, mesoporosity can be introduced in MFI-type zeolites by one of more of the following processes: direct synthesis of zeolites using implanted combustible templates, chemical treatments of the zeolite crystals with bases or acids or both bases and acids, hydrothermal treatments before and/or after acid and/or base post treatments, incorporation of a pore regulator agent (PRA), such as very fine carbon black particles. For example, nanosized particle of carbon-black or combustible organic polymers can be used to create pores above the mesopore region.

One should appreciate that during the catalytic thermoconversion of biomass, the zeolite-based catalyst particles are subjected to hydrothermal treatments, for example during the cracking reaction since steam/water vapor is present during the thermolysis of the biomass and/or during the catalyst particles' stripping/regeneration. Therefore, besides considering the acid or base post synthesis leaching of MFI-type zeolites as a means to create mesoporosity, it may also be important to consider and/or optimize the chemical changes that take place in the zeolite crystallites, such as modification of the density, strength, reactivity and accessibility of the catalytic active sites. Hydrothermal treatments of zeolites, including the conditions in the reactor and regenerator of the conversion unit, can cause a certain dealumination into the zeolite crystallites. This dealumination process can involve removal of aluminum species from the lattice framework and deposition of the species as amorphous nanoparticles into the crystallite pore channels and cavities. The conversion of the crystalline lattice-aluminum sites, which are of the Bronsted type acidity, to the amorphous non-crystalline lattice aluminum species, which are of the Lewis type acid sites, can change the reactivity and selectivity of the zeolite acid sites. The Lewis acidity may be undesirable as it promotes free-radical type reactions that lead to polymerization of the product molecules resulting in heavy and tarry products and coke formation.

### Dealumination of the MFI Tyne Zeolites Using Mild Acid Treatments

In some aspects of the invention, the mesoporosity in the MFI-type zeolite crystal can be created by dealumination of the zeolites. The dealumination process can also increase the thermal stability and increase the silica alumina molar ratio (SAR) of the zeolites. In addition, besides improving the mass-transport properties, active site accessibility and diffusional limitations, the active-site acidity and the total number of acidic active sites can be adjusted, via modification of the zeolite framework and avoid high density of strong acid sites that can cause over cracking and excess coke formation.

In some embodiments, controlled mild acid treatment of the hydrothermally treated MFI-type zeolites can remove at least some NFA species, reduce the Lewis type activity, and the reactivity/selectivity of the zeolites. Therefore, in some embodiments, the controlled acid dealumination can improve the activity/selectivity of the zeolites as well as increase accessibility of the active sites and can enhance the rates of mass transfer to and from the active sites located in the interior of the zeolite crystallites.

In some embodiments, aluminum can be removed from the zeolites by chemical treatment using ammonium hexafluorosilicate, ethylenediaminetetraacetic acid and silicon tetrachloride. However, it should be noted that the hydrothermal treatments of the zeolites prior chemical dealumination, can result in structural lattice rearrangements such that the resulting mesoporosity is not characterized by uniform pores with same sizes and lattice location.

Nevertheless, in general, the creation of a mesopore structure in the zeolite crystals provides pathways that increase the mass transfer and diffusion of the product molecules, while the micropores structure provides the major portion of the acid sites.

Some aspects of the invention relate to cost effective methods for removing aluminum atoms from the zeolite lattice as well as removing NFA that can block pores openings and reduce catalytic activity. In general, the hydrothermal treatments preferentially expel, from the lattice, the weaker acid sites which can transform to NFA species. In some embodiments, MFI-type zeolites can be first subjected to calcination or steam to form non-framework alumina (NFA) which is expelled from the crystal lattice, followed by a lattice atomic rearrangement. The expelled NFA can be removed by the acid dealumination treatment, thus creating certain amount of mesoporosity within the zeolite crystals. The removal of NFA from the zeolite crystals can open the surface pores, since the aluminum sites within the zeolite crystals are more concentrated on the outer-skin of the zeolite crystals. The formation of the hierarchical mesopore structure can increase the crystal interior active site accessibility, producing zeolites with increased catalytic activity and selectivity.

In some embodiments, the dealumination process can be performed in presence of an inorganic acid such as nitric acid, hydrochloric acid, sulphuric acid or the like or mixture of two or more thereof. In some embodiments, the acid can be an organic acid such as acetic acid, oxalic acid, citric acid, and the like, or mixture thereof. In some embodiments, chelating agents (e.g. EDTA) can be used to remove part of the NFA from lattices. In some embodiments, the acid can be used in combination with a chelating agent.

It should be noted that the acid strength per aluminum site can increase with the decrease of the aluminum lattice sites. For example, dealumination of zeolites with high aluminum content can cause an increase of the lattice silica-to-alumina ratio (SAR), and an increase of the strength of the remaining aluminum acid sites. It is known that the hydrothermal treatment of a H(ZSM) or NH4 (ZSM) zeolite produces about 4.6×10²⁰/g acid sites, which have been characterized to be 22, 17, 46 and 15% (of the total) respectively of the weak, medium, strong and ultra strong, wherein the majority are of the Bronsted type (see Ding-Zhu Wang, et al, Applied Catalysis, Vol. 59, 1990, 75-88; P. J. Kooyman, V. Waal, and H. Bekkum, Zeolites, Vol. 18, 1997, 50-53).

In some embodiments, about two third of the MFI-type zeolite lattice alumina, as synthesized, can be removed by dealumination using hydrothermal treatments followed by an acid or other types of aluminum extraction.

In some embodiments, the porosity of the zeolite crystallite can be increased using hydrothermal treatments followed with acid dealumination, or alternatively, after acid leaching, subjecting the zeolite to further steaming and acid leaching. See for example, J. Kornatowski, W. Baur, and G. Pieper, J. Chem. Soc. Faraday Trans., 1992, Vol. 88, 1339-1343; S. Campbell, et al, Journal of Catalysis, 1996, Vol. 161, 338-349 and A. de Lucas, et al, Applied Catalysis A: General, 1997, Vol. 154, 221-240. Steam dealumination can extract framework tetrahedrally coordinated aluminum atoms which convert to distorted octahedral aluminum atoms. Some of these aluminum species can move to the outer surface of the zeolite crystals and form fully octahedrally coordinated aluminum atoms, which have no acidity, but can block crystal openings. Aluminum atoms can be removed by acid leaching to open the blocked feeder-pores located on the zeolite crystals. See for example, T. Masuda, et al, Applied Catalysis A: General, 1998, Vol. 172, 73-83.

In some embodiments, part of the NFA can be reinserted into the lattice during the acid leaching of the steamed MFI-type zeolite which contains NFA, produced, for example, by the steaming dealumination. See T. Sano, et al, Microporous and Mesoporous Materials, 1999, Vol. 31, 89-95. In some embodiments, reinsertion may be minimized by optimizing the acid leaching process conditions (i.e. temperature, time, acid concentration conditions) and/or by repeated rounds of steaming followed by acid leaching.

In some embodiments, the MFI-type zeolite is dealuminated using citric acid and NFA is reinserted back to the zeolite framework. See Kumar, et al, Journal of Molecular Catalysis A: Chemical, 2000, Vol. 154, 115-120; C. Triantafillidis, et al, Microporous and Mesoporous Materials, 2001, Vol. 47, 369-388 and E. van Steen, L. H. Callanan, and M. Claeys, Studies in Surface Science and Catalysis, 2004, Vol. 154, 2688-2695. See Y. Liu, et al, J, Phys. Chem, B, 2008, Vol. 112, 15375-15381 for illustration of the inter-connectivity of micro with the meso pore networks in MFI zeolites with built in hierarchical porous structures.

In some embodiments, the acid dealumination step can be performed on a calcined form of MFI-type zeolite, before the formation of catalyst shaped bodies (also referred herein, as catalyst microspheres or catalyst particles).

In some embodiments, the extracted alumina can be present in the form of soluble salts of the acid used in the dealumination and can be washed out.

Yet in some embodiments, the acid dealumination process can be performed on the calcined or steam treated shaped bodies containing the catalyst components (e.g. clay, binder, silica, alumina, additive and zeolite).

In some embodiments, the dealumination of the protonated calcined or steamed MFI zeolite, (e.g. ZSM-5 type), when incorporated into catalyst microsphere containing alumina as part of the matrix, can be conducted under mild/controlled acid conditions to avoid dissolving part of the matrix alumina or the alumina from the matrix.

In some embodiments, controlled and mild acid leaching can be used to remove NFA, while controlling and maintaining the zeolite crystal bulk porosity.

It should be noted that alumina present in the matrix may not desirable, since the presence of alumina can cause the production of excessive amounts of gas and coke when used in catalysts for catalytic cracking of bio oil feeds. In some embodiments, non-alumina containing matrix, wherein there is no free alumina available to react with the acid, can be used. In some embodiments, silica sols containing zeolite, silica sol binder and clay can be used.

### Alkaline Desilication of MFI Zeolites Using Inorganic Bases

In some aspects of the invention, mesoporosity in the zeolite phase can be created by removing part of the silica of the pre-crystallized or in situ grown zeolites. In some embodiments, the bulk crystal porosity of the MFI-type small pore zeolites, can be increased by controlled treatment with a base to introduce additional pore volume in the mesopore range. In some embodiments, the base can be sodium hydroxide (NaOH), sodium carbonate (Na₂CO₃), sodium bicarbonate (NaHCO₃) or mixture thereof. Overall, the partial desilication of the zeolite can cause an increase in the mesoporosity and an increase in the catalytic activity of the desilicated MFI-type zeolite.

In some embodiments, the catalyst particles comprising in situ grown zeolites can be treated with NaOH and Na₂CO₃, under controlled conditions to obtain the desirable porosity. For example, catalyst particles comprising in situ grown zeolite can be treated with a solution of NaOH and Na₂CO₃ at 80° C. for a suitable time to produce an optimum mesoporosity in the zeolite. In some embodiments, the product can be impregnated with a phosphorous-containing compound and optionally calcined to produce the catalyst particles.

In some embodiments, combination of alkaline desilication followed by mild acid dealumination can be used to create mesoporosity and to modify acidity of the active sites. In some embodiments, a calcination step can be used after the alkaline treatment and before the acid treatment. In some embodiments, the phosphorous-containing compound can be applied to the microspheres after the alkaline treatment, after the acid treatment, after the ion-exchange and/or after the calcination step. In some embodiments, the catalyst particles can be treated with a phosphorous-containing compound after alkaline and/or acid treatment. In some embodiments, the microspheres can be subjected to calcination to fix the phosphorous on the microspheres.

It has been previously shown that sodium hydroxide leaching can remove some of the silica in order to decrease the SAR and to increase the concentration of aluminum sites per unit surface area. In addition, desilication of zeolite crystals, using a base like NaOH, Na₂CO₃, or mixture thereof, results in some stabilization of the aluminum sites. Overall, it has been shown that the partial desilication caused an increase in the mesoporosity and that the catalytic activity of the desilicated MFI-type zeolite can be increased as well. See for example (R. M. Dessau, E. W. Valyocsik, and N. H. Goeke, Zeolites, 1992, Vol. 12, 776-779; G. Lietz, et al, Journal of Catalysis, 1994, Vol. 148, 562-568; R. Le Van Mao, et al, J. Mater. Chem., 1994, Vol. 4, 605-610; A. Cizrnek, et al, Microporous Materials, 1995, Vol. 4, 159-168; Cizmek, et al, Microporous Materials, 1997, Vol. 8, 159-169; R. Le Van Mao, et al, J. Mater. Chem., 1995, Vol. 5, 533-535; R. Le Van Mao, et al, Zeolites, 1997, Vol. 19, 270-278; M. Ogura, et al, Chemistry Letters, 2000, 882-883; C. J. H. Jacobsen, et al, J. Am. Chem., Soc., 2000, Vol. 122, 7116-7117; T. Suzuki, T. Okuhara, Microporous and Mesoporous Materials, 2001, Vol. 43, 83-89; M. Ogura, et al, Applied Catalysis A: General, 2001, Vol. 219, 33-43; V. N. Shetti, et al, Journal of Catalysis, 2008, Vol. 254, 296-303; R. Srivastave, M. Choi, and R. Ryoo, Chem Comm, 2006, 4489-4491; J. Perez-Ramirez, et al, Advanced Functional Materials, 2009, Vol. 19, 3972-3979; L. Su, et al, Catalysis Letters, 2003, Vol. 91, 155-167.

In some embodiments, combination of alkaline desilication followed with mild acid dealumination can be used to create mesoporosity and modify acidity for MFI-type zeolites. See for example, modification of zeolites used for hydrocarbon conversion reaction, C. Fernandez, et al, Chemistry A European Journal, 2010, Vol. 16, 6224-6233; J. C. Groen, et al, Microporous and Mesoporous Materials, 2005, Vol. 87, 153-161; R. Caicedo, et al, Microporous and Mesoporous Materials, 2010, Vol. 128, 91-100.

In some embodiments, mesoporosity can be created and NFA can be removed by desilication, followed by steaming and mild acid dealumination.

In some embodiments, MFI-type zeolite can be grown in presence of combustible pore regulating agent (PRA) such as organic molecules, polymers, starch, calcium carbonate, carbon black etc., and the pore regulating agent can be burned off to create an extra intra-crystal porosity. (see for example, Y. H. Chou, et al, Microporous and Mesoporous Material, 2006, Vol. 89, 78-87; Z. Yang, Y. Xia, and R. Mokaya, Advanced Materials, 2004, Vol. 16, 727-732; L. Wang, et al, Colloids and Surfaces A: Physicochem. Eng. Aspects, 2009, Vol. 340, 126-130; J. Zhou, et al, ACS Catalysis, 2011, Vol. 1, 287-291; H. Zhu, et al, Chem. Mater, 2008, Vol. 20, 1134-1139).

In some embodiments, the in situ grown MFI-type zeolite can be ion-exchanged with metal ions in mono-, di- or trivalent ionic forms.

As noted above, acid or alkaline post synthesis leaching of MFI can create mesoporosity within the zeolite crystals. In addition, chemical changes that take place in the zeolites crystals and that can modify the density, strength, reactivity and/or accessibility of the catalytic active sites can be optimized. One skilled in the art would appreciate that hydrothermal treatments of zeolites (including the conditions in the reactor and regenerator of the conversion unit) can cause a certain dealumination of the zeolite crystals. This dealumination involves removal of aluminum species from the lattice framework and deposition of the NFA as amorphous nanoparticles phases into the zeolite crystals' pores channels and cavities. The conversion of the crystalline lattice-aluminum sites, which are of the Bronsted type acidity, to the amorphous non-crystalline lattice aluminum species, which are of the Lewis type acid sites, can change the reactivity and selectivity of the zeolite acid sites. The Lewis acidity is generally undesirable as it can promote free-radical type of reactions that lead to polymerization of the product molecules resulting to the formation of heavy and tarry products and coke. In some embodiments, controlled and mild acid treatment of the hydrothermally treated MFI zeolites can be used to remove some of these NFA species and reduce the Lewis type activity.

Accordingly, in some embodiments, mild and/or controlled acid dealumination of the MFI zeolite can be used to improve the activity/selectivity of the zeolite as well as increase accessibility of the active sites and enhance the rates of mass transfer to and from the active sites located in the interior of the zeolite crystals.

### II. Matrix Phase:

In some embodiments, the matrix can be a non-zeolitic inorganic matrix such as silica, alumina, or a combination of silica and alumina, a clay, a modified clay, or combinations thereof. In some embodiments, the modified clay is a calcined clay, an acid-leached clay or base-leached clay, or dealuminated clay or combinations thereof. In some embodiments, the clay is a kaolin clay, a calcined kaolin clay or mixtures thereof. In some embodiments, the matrix can be a synthetic clay, such as a layered double hydroxide, delaminated or chemically modified delaminated clay.

Some aspects of the invention relate to the formation of catalyst particles having larger pore and channels. Such large interconnecting pathways within the matrix and microsphere particles allow the zeolite crystals to be homogeneously suspended, dispersed, and be sufficiently accessible to the reactant oil-feed molecules and at the same time allow the cracked product molecules formed on the zeolite active sites to diffuse out of the zeolite crystals and of the catalyst microspherical particles. Increasing the diffusion rates can minimize cross interactions between the product molecules and the entering reactant molecules, and minimize undesirable side reactions that can lead to the formation of coke and light gases.

In some embodiments, methods for making catalyst particles in a cost effective manner are disclosed.

It should however be noted that, as previously described, when the catalyst particles have large bulk porosities and pathways, the physical strength of the microspheres can be reduced resulting in a loss of the attrition resistance. Such loss of attrition can be disadvantageous when the particles are used in the fluidized bed reactor with very short residence times. Therefore, in some embodiments, the particle bulk porosity is optimized such that the particles maintain the physical strength required for use in biomass thermolysis conditions.

In some aspects of the invention, the catalyst microsphere particle can be designed to have a suitable particle bulk architecture such as three dimensional interconnecting pathways within the bulk of the catalyst particle to enable full potential of the catalytic active sites of the zeolite and minimize the undesirable side reactions.

In a simplified model, the catalyst comprises a matrix and a zeolite component with connected conduits, each component having a plurality of pores, cavities and interconnecting channels, some of which being aligned and providing free pathways leading from the pores at the surface of the catalyst particles to the interior of the zeolite crystal and to the active site locations.

In order for the reactant molecules to be able to react with the zeolite active sites located in the bulk of the zeolite crystal, the reactant molecules need to travel through the microsphere particle matrix and through the zeolite crystal. This journey involves diffusing first through the pores and pathways provided by the matrix and then through the pores and pathways of the zeolite crystals. If the pores and pathways within the matrix are larger than those of the zeolite, the passage of the reactant molecules can be facilitated and non-selective thermal cracking at the pore openings, which may result in coke deposits, can be avoided. Coke deposits resulting in pore blockage can restrict the diffusion of reactant molecules, increasing the residence time of the reactant molecule within the matrix. This can cause non-selective cracking and additional coke and gas formation, thus rendering the zeolite less effective and less selective. In addition, if the openings of the pores/channels are not sufficiently large, metals can be deposited at the pore openings further hindering and limiting the diffusion of the reactant molecules through the matrix to the zeolite crystals. In other words, it can be envisioned that the reactant molecules move through a multi-lane channeled super highway which leads them to the zeolite crystal pore openings and to narrow pathways that lead to the catalyst active sites in the interior of the zeolite crystals. This represents the in-bound traveling mass towards the zeolite active sites located in the interior of the zeolite crystals.

One skilled in the art will appreciate that the overall mass diffusion process is more complicated since the reactant molecules can be converted into lighter molecules at the zeolite catalytically active sites. These lighter molecules need also to be able to exit the bulk of the zeolite crystals, and to use the matrix pathways to exit the catalyst microsphere particles as a gas phase. To facilitate the cross-diffusion of the in-bound reactant molecules and the out-bound reactant products, both the matrix and the zeolite phases need to have large and interconnecting pathways (or channels), and minimum hindrance.

Matrix and zeolite diffusional limitations can be more pronounced when the oil feed contains larger size molecules, such as the poly nuclear aromatic molecules, increasing the overall residence times within the zeolitic and the matrix phases, and resulting in side-cross-reactions between the catalytically converted products and between the reactant molecules and the catalytically converted products. Such side-reactions can form undesirable by-products because the nascent molecular species produced by the cracking of the reactant molecules are in the form of free-radicals before being transformed into stable products. The free radicals can be highly reactive and interact within themselves and/or the incoming reactant molecules, resulting in longer residence times due to restricted diffusion, and resulting in coke formation and metal deposits which can plug the pore openings and inactivate the zeolite crystals.

For heavy oil feeds, and in particular for bio-oils containing large poly nuclear aromatic molecules, pores with diameters of about 100 angstrom or 200 angstrom can cause diffusional restrictions. The inherent tendency of the large poly nuclear aromatic molecules to form coke can be substantially enhanced by the restricted diffusion through the smaller pore openings and pathways of the matrix. Larger molecules can coat the walls of the pathways, decreasing the effective free-space available for the rest of the reactant molecules diffusing towards the catalyst active sites. Consequently, according to some embodiments, it would be advantageous when handling oil feeds containing large poly nuclear aromatic molecules, to use matrixes having appropriate pore volumes and reduced diffusional limitations. In some embodiments, the catalyst particles have large pores and pathways throughout the matrix and the zeolite crystals for efficient and selective conversion process. Considering that the heavy oil resid feeds and the different kinds of bio-oils derived from the thermoconversion or catalytic thermoconversion of various kind of biomass can contain a very wide spectrum of molecules with different sizes, in some embodiments, the matrix can be designed to have a large portion of its pore volume with pore sizes suitable to accommodate the portion of feed having large size molecules ranging from about 300 to 800 angstrom. In some embodiments, under a steady-state equilibrium condition, the diffusion rates of the reactants and products in and out of the catalyst particle may be equal.

Further, there can be a certain amount of non-selective thermal cracking taking place within the matrix, primarily producing additional light gases and additional coke that can be deposited within the pores. This can result in a further restriction of the diffusion of the reactant molecules towards the zeolite crystals. The accessibility of the active sites can then be further restricted as the diffusion through the matrix is the controlling rate.

Still further, in most matrix compositions such as silica-alumina, alumina, alumina-phosphates, titania, titania-alumina and the like, the active acid sites can crack some of the molecules of the feed into smaller molecules, such as “alkyl-species”. These smaller cracked “alkyl” products can be the feed to the zeolite active sites.

An additional benefit of catalysts with matrixes having large pore openings and channels, relates to the rates of catalyst deactivation and subsequent catalyst regeneration in term of burning off the deposited coke. Catalysts with matrixes having larger pore openings can exhibit slower deactivation and faster regeneration rates for burning the coke off the catalyst particles.

One skilled in the art will appreciate that catalyst microspheres with super porosities having large diameter pore sizes can weaken the particle mechanical/physical strength and cause breaking of the catalyst particles. As the catalyst particles are continuously circulated in the fluid bed reactor with considerable high velocities, moving through slide values and other tortuous parts of the circulating system, including the regenerator stripper, etc, the catalyst particles are subjected to a substantial amount of mechanical impacts, as well as collisional impacts between the individual particles and the walls of the vessels and reactor. To be able to maintain the particle integrity and avoid loss of mass, the catalyst particles must exhibit a certain amount of physical/mechanical strength and have a reasonable attrition resistance. As such, in some embodiments, the catalyst particles composition and architecture can be optimized to have suitable attrition resistance and catalytic site porosity accessibility.

Aspects of the invention relate to catalyst compositions comprising matrixes exhibiting hierarchical pore structures for use in the catalytic thermoconversion of solid biomass material into liquid fuels or specialty chemicals. As discussed above, in order to develop effective catalysts for use in the catalytic thermolysis of the biomass, since the produced molecules from the biomass thermal decomposition have large size, and since the reactant molecules and catalyst particles are in contact only for a short residence time, it can be advantageous that the catalyst matrix contains large pores and pathways for the reactant molecules and cracked products to be transported in and out of catalyst particle rapidly and with minimum diffusional hindrance. In other words, the reactant molecules need to have sufficient accessibility to the zeolitic crystal through the matrix pores and pathways and to the zeolite active sites located within the bulk of the zeolite crystal.

In some aspects, the invention relates to catalyst compositions comprising zeolites on a matrix having custom-made or engineered hierarchical pore structures. Such compositions allow for the reactant oil-feed molecules to come directly in contact with the catalytically active sites located in the zeolitic phase, without being retarded by matrix diffusion limitations.

In some embodiments, the chemical composition and pore architecture of the catalyst particle can be optimized to achieve minimal matrix accessibility limitation. For example, the number of active catalyst sites located in the matrix and in the zeolite, the pores' volume and pores' size of the matrix and the crystal zeolites can be optimized for use in catalytic thermolysis of biomass.

It should be noted, that catalyst compositions, besides being exposed to continuous impacting with metallic surfaces when introduced and moved through the thermoconversion reactor, can be additionally impacted by collisions with the solid biomass feed particles. When biomass feed particles contain inorganic matter, for example clays, sand, etc., the collision of the catalyst with such biomass particles may cause more attrition to the catalyst particle mass.

The attrited material produced by the fracture and/or by the surface grinding of the catalyst particle may include smaller fragmented particles and microfines, having sizes down to submicron and to the colloidal ranges.

The submicron attrited particles may react with the nascent formed bioacids in the hot reactor environment, to form other organometallic colloidal complexes. In some cases, such very fine dispersions of sub-micron colloidal formed materials may end up being dispersed in the oil phase product coming out from the thermoconversion process. Although it may be difficult and costly to remove these mixtures of fine particles and colloidal phases from the bio-oil, it is generally necessary to remove these mixtures from the bio-oil to obtain a substantially clean bio-oil to be used as a feed to the hydroprocessing reactors containing the hydrotreating catalyst. Removal of mixtures of fine particles and colloidal phases from the bio-oil can avoid catalyst deactivation, flow plugging and/or back pressure increase.

In some embodiments, in order to facilitate the overall upgrading process of the crude bio-oil, including filtrations, water phase separation and in order to protect the catalyst during the hydrotreating steps, catalysts for the thermoconversion may exhibit suitable attrition resistance to the overall exposure the catalyst experiences. In some embodiments, the catalyst compositions can exhibit high attrition resistance to the mechanical exposure with the metal surfaces of the reactor including valves, feeders, cyclones, and the like, with the biomass and with metallic contaminants associated with the biomass. In some embodiments, the catalyst compositions can exhibit high attrition resistance to chemical exposure such as the hot acidic compounds generated by the thermoconversion of biomass in the reactor.

Aspects of the invention provide methods to form microsphere particles that have larger pore and channels throughout the catalyst particle and zeolites. Such large interconnecting pathways within the matrix and microsphere particles allow the zeolite crystals to be homogeneously suspended, dispersed, and to be sufficiently accessible to the reactant oil-feed molecules. The zeolitic and matrix phases can be modified to exhibit suitable attrition resistance and/or be more effective in the catalytic thermoconversion of biomass to bio-oils and hence in reducing the coke formation and/or catalyst deactivation rates.

In some embodiments, the matrix comprises silica, alumina, transitional metal oxide or combination thereof. For example, the transitional metal oxide can be titanium dioxide or zirconium dioxide.

In some embodiments, the method for making catalyst compositions comprises forming a slurry containing a clay and binder components, and incorporating in the slurry an organic material or pore regulating agent, in a fine particular size form. In some embodiments, the organic material can be calcined in air, so that when the material escapes from the catalyst microsphere in a gaseous form, it leaves behind extra bulk porosity and pathways.

### Preparation of Matrixes Exhibiting Hierarchical Pore Structures

In some embodiments, the method comprises incorporating in the slurry containing clay and binder components, a combustible organic material. In some embodiments, the combustible organic material is in a fine particular size form. In some embodiments, the combustible organic material is combustible when calcined.

In some embodiments, the methods for making catalyst compositions comprises the steps of (a) forming a slurry comprising the catalyst components and a combustible pore regulating agent in a fine particular form; (b) forming shaped bodies and (c) burning off the pore regulating agent to form shaped bodies with designed meso and macro hierarchical pore structure.

In some embodiments, the combustible organic material can be calcined in air so that when the material escapes form the catalysts particle in a gaseous form, it leaved behind extra bulk porosity and pathways.

The calcination can be carried out at a temperature from about 200° C. to about 800° C. for a time from about 0.1 hour to about 100 hours. In some embodiments, the calcination step is carried out at a temperature from about 550° C. to about 650° C. In some embodiments, the calcination step is carried out at about 600° C.

In some embodiments, the hierarchical pore structure of the matrix comprises pore sizes ranging from about 20 to about 5,000 angstrom, from about 50 to about 5,000 angstrom, from about 100 to about 5,000 angstrom, from about 100 to about 6,000 angstrom, from about 200 to about 2,000 angstrom, from about 100 to about 2,000 angstrom, or from about 500 to about 5,000 angstrom.

It has been shown that carbon black particles can be used as a pore regulating agent. However, although carbon black materials are available in particle sizes and uniformity suitable for use as combustible pore regulating agents, these materials are considered hazardous to human health. Animal studies suggest long term exposure may increase a person's risk of cancer. The International Agency for Research on Cancer (IARC) has evaluated and considered that the carbon black is possibly carcinogenic to humans (Group 2B). Further risk of possible respiratory diseases after long term exposure has been reported, for possible bronchitis and chronic condition, such as Obstructive Pulmonary Disease, in the lungs as well as causing irritation to the upper respiratory track. Besides its possible health hazards of carbon black, carbon black is highly expensive and its use in commercial quantities for the production of catalysts for the catalytic conversion of biomass or bio crudes can be prohibiting.

Soluble organic polymers have been used as pore regulating agents, primarily in catalysts for HDS, HDN and HDM. See for example U.S. Pat. No. 4,016,106, U.S. Pat. No. 4,016,107 and U.S. Pat. No. 4,016,108 and D. Basmadjian et al. Journal of Catalysis vol. 1 (1962) p. 547-563. Soluble organic polymers can present the disadvantage that they increase the pore volume in the macro and the micro pore regions. Thus, soluble organic polymers may broaden the overall pore size distribution by adding more pore volume in the small pore size regions that include the micro and the meso pores. Further, organic polymers soluble in water or in solvent can be expensive as are the carbon blacks. Therefore, because of these key limitations soluble organic polymers may not be suitable for use in the production of catalysts for the catalytic thermolysis of biomass or the upgrading of bio-oils.

In some embodiments, low cost materials derived from agricultural products can be used as pore regulating agents. These materials have the advantage of not being hazardous to human health, being producible at relative low cost compared to known pore regulating agents such as carbon black and soluble organic polymers. These materials can include, but are not limited to, cellulosic types, starches, sawdust, corn flowers, wood flowers, shortgum, gums, and the like, and mixtures thereof. Another category of combustible organic materials includes, but are not limited to, the waste plastics now being selected and collected from the municipal solid waste. Such materials can be crushed to small size chips, ground and pulverized in high energy mills to produce fine powders having particles sizes in the micron and submicron region. For example, micronizing particles can be performed using vortex cyclonic jet mills, as described in U.S. Pat. No. 6,971,594.

Using similar micronizing and pulverizing techniques, materials with lignocellulosic compositions such as woody materials from forestry or agricultural cellulose products such as corn stover, sugar bagasse, etc. can be processed similarly to fine powders with small defined particle sizes in the micron and submicron ranges. In some embodiments, the organic materials may include, saw dust produced in wood mills.

### Methods for Making

In some aspects of the invention, the method for preparing a biomass catalyst system comprises (a) modifying a zeolite to form a zeolite having a hierarchical microporous-mesoporous structure; (b) preparing a slurry precursor mixture by mixing the modified zeolite, a non-zeolitic inorganic matrix, a binder, a combustible organic compound in water; (c) shaping the mixture to form shaped bodies; and (d) thermally treating the shaped bodies to remove the combustible organic compound, wherein the biomass catalyst system has a matrix phase having a hierarchical mesoporous-macroporous structure and a zeolite phase having a microporous-mesoporous hierarchical structure.

In some embodiments, the step of modifying the zeolite comprises (i) thermally treating the zeolite to form a non-framework alumina; and (ii) treating the thermally treated zeolite with a mild acid to remove the non-framework alumina. In some embodiments, the acid can be an organic acid, such as is nitric acid, hydrochloric acid, sulfuric acid or mixture thereof, or an inorganic acid, such as acetic acid, oxalic acid, citric acid or mixture thereof. In some embodiments, the thermally treated zeolite can be treated with a mild acid in combination with a chelating agent.

In some embodiments, the step of modifying comprises (i) treating the zeolite with a base to remove part of the silica framework. In some embodiments, the base is sodium hydroxide, sodium carbonate, sodium bicarbonate, sodium aluminate or a mixture thereof. In some embodiments, the step of modifying further comprises (ii) treating the base treated zeolite with a mild acid.

In some embodiments, the method further comprises treating the shaped bodies with a mild acid solution to dealuminate the zeolite before step (d). In some embodiments, the method further comprises preparing a slurry of zeolite seeding material in presence of a pore regulating agent and thermally treating the slurry to form the zeolite prior to step (a).

In some embodiments, methods for making catalyst particles comprising in situ crystallized zeolites having a hierarchical pore structure ranging from 20 to 1,000 Angstrom pore sizes, are disclosed. In some embodiments, the catalyst particles comprise a non-zeolitic matrix having a hierarchical pore structure ranging from 50 to 5,000 Angstrom pore size. In some embodiments, the catalyst particles further comprise a binder. For example, the binder can be silica, alumina, silica alumina or phosphate. In some embodiments, the catalyst particles further comprise phosphorous or a phosphorous containing compound.

In some embodiments, the method for making catalyst particles comprises the steps of (a) forming a slurry comprising the catalyst components; (b) forming shaped bodies; (c) preparing a slurry comprising the shaped bodies in presence of a zeolite seeding material, and optionally and an alumina source, a silica source or an alumina source and a silica source; (d) thermally treating the slurry to form matrix/zeolite composite shaped bodies; and (e) chemically treating the composite shaped bodies to form a meso hierarchical pore structure in the zeolite phase and a meso and macro hierarchical pore structure in the matrix phase.

In some embodiments, the method for making catalyst compositions comprises the steps of (a) forming a slurry comprising the catalyst components and a combustible pore regulating agent in a fine particular form; (b) forming shaped bodies; (c) burning off the pore regulating agent to form shaped bodies with designed meso and macro hierarchical pore structure; (d) preparing a slurry comprising the shaped bodies in presence of a zeolite seeding material, and an alumina source, and a silica source; (e) thermally treating the slurry to form a matrix/zeolite composite; and (f) chemically treating the composite shaped bodies to form a meso hierarchical pore structure in the zeolite phase, in a matrix having a meso and macro hierarchical pore structure.

In some embodiments, the method comprises preparing a slurry comprising the shaped bodies in presence of a zeolite seeding material, and an alumina source or a silica source or without any alumina or silica source. In some embodiments, the zeolite seeding material comprises ZSM or Na—Y zeolite seeds. In some embodiments, the silica and/or alumina composition is adjusted by adding an alumina or silica source. The slurry can be aged in an autoclave at 170° C. to allow for the zeolite to grow on the microspheres. See, for example, U.S. Pat. Nos. 6,908,603 and 7,344,605, which are incorporated herein by reference in their entirety.

In some embodiments, the catalyst particles' bulk porosity can be optimized against the required particles' physical strength and attrition resistance when used in the fluidized bed reactor with very short residence times. Accordingly, the catalyst particles disclosed herein exhibit improved conversion and selectivity, and improved bio-oil yield while maintaining adequate attrition resistance properties for use in biomass conversion and minimizing undesirable products such as coke and hydrogenated gases. Said catalyst particles may be used also for upgrading bio-oils.

In some embodiments, the method of making the catalyst particles comprises forming a slurry precursor mixture containing clay material, optionally a binder, and incorporating in the slurry an organic material or pore regulating agent (PRA). In some embodiments, the slurry can formed into shaped bodies (e.g. microspheres), for example by spray drying.

In some embodiments, one or more of the following process can be used to modify the clay matrix. In some embodiments, the clay(s) can be modified before spray drying to form the microspheres. For example, the clay may be mixed with PRAs and/or may include inorganic materials with different particle sizes and/or morphologies. In some embodiments, the pore regulating agent is carbon black. In some embodiments, the microspheres can be chemically modified after having been formed. In some embodiments, the microspheres can be calcined. The resulting microspheres exhibiting meso/macroporosity can be subjected to zeolitization.

In some embodiments, the organic material can be combustible when calcined in air, so that when the organic material escapes from the catalyst microsphere in a gaseous form, it leaves behind extra bulk porosity and pathways. The calcination can be carried out at a temperature from about 200° C. to about 800° C., for a time from about 0.1 hour to about 100 hours. In some embodiments, the calcination step is carried out at a temperature from about 550° C. to about 650° C. In some embodiments, the calcination step is carried out at about 600° C.

In some embodiments, the hierarchical pore structure of the matrix comprises pore sizes ranging from about 50 to about 5,000 angstrom, from about 100 to about 5,000 angstrom, from about 100 to about 6,000 angstrom, from about 200 to about 2,000 angstrom, from about 100 to about 2,000 angstrom, or from about 500 to about 5,000 angstrom.

In some embodiments, catalyst particles having a hierarchical meso/macro porous structure can be formed using a clay or portion of the clay that has a different particle morphology than the hydrous kaolin clay, such as, for example, delaminated kaolin, halloysite, diatomaceous earth, sepiolite, attapulgite or combinations thereof. Using a mixture of different particle morphology can increase the size of the pores within the matrix. These materials which have different particle morphologies than kaolin clay can be included in the microsphere together with the organic PRA before the slurry is spray dried to form the microspheres. The components with different particle morphologies can also be subjected to the same chemical treatments the kaolin microspheres are subjected to in order to form meso/macroporosities.

In some embodiments, the clay can be first treated with an acid or base to leach out some of the lattice metals. Delaminated clay, such as delaminated kaolin, may optionally be calcined. The delaminated clay can be treated with an acid to remove a portion of the clay-lattice alumina, or with an alkaline to remove a portion of the clay-lattice silica.

In some embodiments, the microspheres or shaped bodies containing pore regulating agent (PRA) can be acid leached. The acid leaching of the shaped bodies containing the pore regulating agent can be done after a calcination step that may remove (e.g. by burning off) the pore regulating agent. Leaching the shaped bodies after the calcination step can have the advantage of forming physically stronger shaped bodies that can retain their shape and strength during the acid leaching process. Alternatively, the calcined clay (e.g. calcined kaolin clay) can be acid-leached before it is formed into shaped bodies. In some embodiments, the calcined shaped bodies can be base-leached to remove part of the silica from the clay and increase its porosity. The base-leached can be used for the formation of the catalyst composition with proper adjustments of the silica content and seeds addition as described below.

In some embodiments, the methods of making the catalyst compositions comprises forming clay-based microspheres comprising a carbohydrate combustible pore regulating material such as, for example, wood flour, and calcining microspheres. The calcined microsphere can subsequently be acid leached to remove a portion of the alumina content of the clay phase.

In some embodiments, the catalyst microsphere bulk porosity can be optimized against its required physical strength and attrition resistance when used in the fluidized bed reactor with very short residence times.

In some embodiments, clays with different particle morphologies can be used in combination with dealuminated or desilicated clays.

In some embodiments, combinations of alumino-silicate, alumina, silica that have been calcined to form transition phases, for example spinels or mixed-metal-oxides phases can be used.

In some embodiments, the catalyst can be prepared using kaolin clays that have been delaminated, desilicated, or dealuminated before the clay(s) is spray dried into microspheres.

In some embodiments, the clay material can be used in combination with a pore regulating agent, such as a combustible material. The combustible material can comprise a plastic, resin, rubber, carbohydrates or combinations thereof.

Subsequently, said meso/macroporous microspheres can be slurried in water solutions with an alumina and a silica source, and in presence of zeolite seeding material to form MFI-type zeolites or beta-zeolites onto the macroporous microspheres, by aging under autogenous pressure in an autoclave. Subsequently, the composite microspheres containing the in situ grown MFI-type zeolite or beta-zeolite are subjected to a chemical treatment. In some embodiments, the microspheres are chemically treated using a solution of NaCO₃, NaOH, or combination thereof. For example, the microspheres can be chemically treated with a mixture of NaCO₃ and NaOH at 80° C., for a time suitable to cause a certain amount of desilication of the MFI-type zeolite, and/or suitable to produce the desired hierarchical mesoporosity of the in situ grown MFI-type zeolite on the hierarchical macroporous clay matrix. The resulting catalyst is a zeolite/matrix composite microsphere exhibiting a hierarchical porosity. In particular, the resulting catalyst can have superimposed micro/meso and macroporosities.

In other embodiments, the composite matrix/zeolite microspheres are chemically treated with acids or with acids and bases. In some embodiments, the microspheres can be treated prior to growing in situ the zeolite. Optionally, calcination or steaming treatment can be applied before the chemical treatment.

One skilled in the art will appreciate that biomass or products derived from pyrolysis of the biomass, such as oil/vapor products, can be distinguished from products containing fossil carbon by the carbon ¹⁴C isotope content (also referred herein as radiocarbon).

Carbon ¹⁴C isotope is unstable, having a half life of 5730 years and the relative abundance of carbon ¹⁴C isotope relative to the stable carbon ¹³C isotope can enable distinction between fossil and biomass feedstocks. In some embodiments, the presence of ¹⁴C isotope can be considered as an indication that the feedstocks or products from pyrolysis include renewable carbon rather than fossil fuel-based or petroleum-based carbon. Carbon ¹⁴C isotope of the total carbon content of renewable feedstock or products derived from renewable feedstock is typically 100% whereas the carbon ¹⁴C isotope of the total carbon content of petroleum-based compounds is typically 0%.

Assessment of the renewably based carbon content of a material can be performed through standard test methods, e.g. using radiocarbon and isotope ratio mass spectrometry analysis. ASTM International (formally known as the American Society for Testing and Materials) has established a standard method for assessing the biobased or renewable carbon content of materials. The application of the ASTM-D6866 can be used to derive biobased or renewable carbon content. The analysis can be performed by deriving a ratio of the amount of carbon ¹⁴C in an unknown sample compared to that of a modern reference standard. This ratio is reported as percent modern carbon or pMC. The distribution of carbon ¹⁴C isotope within the atmosphere has been approximated since its appearance, showing values that are greater than 100 pMC for plants and animals living since AD 1950. The distribution of carbon ¹⁴C isotope has gradually decreased over time with values of about 107.5 pMC. In some embodiments, biomass or compounds derived from biomass have a carbon ¹⁴C signature of about 107.5 pMC.

Some aspects of the invention relate to compositions comprising a catalyst system having a clay matrix and in situ crystallized zeolites having a hierarchical pore structure ranging from 20 to 1,000 Angstrom pore size; and a feedstock having a carbon ¹⁴C isotope content of about 107 pMC. Other aspects of the invention relate to compositions comprising a catalyst system having in situ crystallized zeolites having a hierarchical pore structure ranging from 20 to 1,000 Angstrom pore size into a clay matrix having a hierarchical pore structure ranging from about 50 to about 5,000 angstrom; and a feedstock having a carbon ¹⁴C isotope content of about 107 pMC.

In some embodiments, the feedstock is a particulated biomass, or is a product derived from pyrolysis of biomass. In some embodiments, the feedstock is bio-oil vapor or a bio-oil.

The present invention provides among other things catalysts systems, processes of making the catalyst systems, methods for converting biomass into fuel and chemicals and methods for upgrading bio-oils. While specific embodiments of the subject invention have been discussed, the description herein is illustrative and not restrictive. Many variations of the invention will be come apparent to those skilled in the art upon review of this specification. The full scope of the invention should be determined by reference to the claims, along with their full scope of equivalents, and the specification, along with such variations.

The following examples are intended to be illustrative of the present invention in order to teach one of ordinary skill in the art to make and use the invention and are not intended to limit the scope of the invention in any way.

### EXAMPLES

### Example 1

A steamed HZSM-5 zeolite is dealuminated with a mild solution of HCL, washed and filtered. The dealuminated HZSM-5 zeolite is then incorporated in a matrix containing clay, silica sol, boehmite alumina, and carbon black, and spray dried to from shaped bodies. The shaped bodies are subjected to calcination to burn off the carbon black creating macroporous microspheres containing mesoporous HZSM-5 zeolite. In some embodiments, the MFI zeolites are phosphated when used in catalyst compositions. Phosphates can be applied to the MFI zeolite before incorporation into the microsphere or on the microsphere which contains the zeolite.

### Example 2

A steamed H-MFI zeolite is treated with NaOH to remove part of the silica and form a hierarchical mesoporosity. This zeolite is incorporated in a matrix containing clay, silica sol, boehmite alumina, and carbon black, spray dried to from shaped bodies. The shaped bodies are subjected to calcination to burn off the carbon black form macroporous microspheres comprising the mesoporous MFI zeolite. In some embodiments, the MFI zeolites are phosphated when used in catalyst compositions. Phosphates can be applied to the MFI zeolite before incorporation into the microsphere or on the microsphere which contains the zeolite.

### Example 3

Other embodiments involve the use of mesoporous ZSM zeolites compounded in a matrix and PRA's described in U.S. Pat. No. 4,016,106 and US Patent Application No. US2002/0165083, incorporated herein by reference in their entirety.

### Example 4

In some embodiments, MFI zeolite is thermally treated and subjected to an inorganic or organic acid treatment, to remove portions of the NFA (which are produced by the thermal treatment of the H⁺ or NH4⁺ forms of the MFI zeolites) and create intracrystalline mesoporosity. The zeolite is incorporated in the catalyst matrix which contains a combustible additive. Upon calcination, the organic matter is burned off and meso/macro porosity is created into catalyst particle. In some embodiments, the MFI zeolites are phosphated when used in catalyst compositions. Phosphates can be applied to the MFI zeolite before incorporation into the microsphere or on the microsphere which contains the zeolite.

### Example 5

In some embodiments, the MFI zeolite is treated with a base such as NaOH, Na₂CO₃ or a mixture thereof to remove part of the framework silica and thus create a mesoporous intracrystalline structure. The mesoporous MFI zeolite is slurried in water together with clay, silicon based binder and a combustible organic polymer material, and spray dried to form microspheres. The microspheres are calcined to remove the organic polymer and create macroporosity in the catalyst particles. In some embodiments, the MFI zeolites are phosphated when used in catalyst compositions. Phosphates can be applied to the MFI zeolite before incorporation into the microsphere or on the microsphere which contains the zeolite.

### Example 6

In some embodiments, the MFI zeolite is treated with a base such as NaOH, or Na₂CO₃ to remove part of silicon atoms from the zeolite framework, and subsequently treated with a mild acid. The mesoporous MFI zeolite produced is mixed in a slurry with a silica sol binder, clay and an organic combustible material, and spray dried. Subsequently, the microspheres are calcined to remove the organic polymers and form a catalyst exhibiting a multiscale functional micro/meso/macro porosity structure. In some embodiments, the MFI zeolites are phosphated when used in catalyst compositions. Phosphates can be applied to the MFI zeolite before incorporation into the microsphere or on the microsphere which contains the zeolite.

### Example 7

In some embodiments, a catalyst composition is prepared in a slurry comprising H-ZSM zeolite, a silica sol binder, a combustible organic polymer, and kaolin clay and spray dried the slurry to form microspheres. The microspheres are steamed and subsequently treated with a mild acid solution sufficient to dealuminate the zeolite. The treated microspheres are subjected to calcination to burn off the organic polymer. In some embodiments, the MFI zeolites are phosphated when used in catalyst compositions. Phosphates can be applied to the MFI zeolite before incorporation into the microsphere or on the microsphere which contains the zeolite.

### Example 8

In some embodiments, the MFI zeolite is grown in the presence of nano-sized carbon black powder and then compounded in a slurry together with silica sol binder, clay and a pore regulating agent such as starch. The slurry is spray dried to form microspheres. Subsequently, microspheres are calcined to burn off the carbon black and induce meso porosity into MFI zeolite and to burn off the starch and form the meso/macro-porosity in the catalyst particle matrix.

In some embodiments, the MFI zeolites are phosphated when used in catalyst compositions. Phosphates can be applied to the MFI zeolite before incorporation into the microsphere or on the microsphere which contains the zeolite.

### Example 9

In some embodiments, the MFI zeolite used is grown with a large organic template, and compounded in a slurry together with a silica-alumina binder, clay and sugar as a pore regulating agent. The slurry is spray dried to form microspheres. Subsequently, the microspheres are calcined to remove the organic template from the MFI zeolite to form mesopores in the MFI zeolite and also burn off the sugar PRA from the matrix to form the meso/macro-pores in the matrix. The MFI mesopores and the matrix meso/macro pores form a continuous multiscale functional porosity in the microsphere catalyst particle.

### Example 10

In some embodiments, a mesoporous MFI ZSM zeolite is compounded in a slurry with a soluble organic polymer, silica-alumina binder and clay, spray dried and calcined to remove the organic polymer.

### Example 11

In some embodiments, a mesoporous MFI ZSM zeolite is compounded into a slurry with carbon black using the formation described in U.S. Pat. No. 4,356,113, incorporated herein by reference in its entirety.

### Example 12

In some embodiments, the MFI ZSM zeolite is phosphated, steamed or calcined and mildly dealuminated to form mesoporosity. The zeolite is then compounded into a slurry containing silica sol binder, particular colloidal silica clay and a combustible carbohydrate pore regulating agent. The silica binder preparation is described in U.S. Pat. No. 3,867,308, incorporated herein by reference in their entirety. The slurry is spray dried and then calcined to form a continuum of meso and meso/macro multiscale hierarchical functional porosity.

### Example 13

In some embodiments, the mesoporous ZSM or beta-zeolite is compounded in a slurry containing silica sol binder, rod-shaped clay, like halloysite, and diatomaceous earth, and kaolin clay and a combustible organic pore regulating agent. The slurry is spray dried to form microspheres. Microspheres are calcined to burn off the organic pore regulating agent and to create matrix meso/macro pores in the matrix. In some embodiments, the rare earth exchanged Faujasite (Y) zeolite is replaced with USY zeolite or dealuminated USY zeolite.

### Example 14

In some embodiments, a mixture of mesoporous ZSM or beta-zeolite and rare earth exchanged Faujasite zeolite is mix with water, silica sol binder, clay and a combustible organic binder to form a slurry. The slurry is spray dried to from microspheres. Microspheres are calcined to burn off the organic binder. In some embodiments, the rare earth exchanged Faujasite (Y) zeolite is replaced with USY zeolite or dealuminated USY zeolite.

### Example 15

700 grams of a formed microspheroidal standard catalyst containing 40% HZSM-5 was stirred with 14 liters of 0.2 molar NaOH solution (ratio solid to solution=1:20) at 80° C. for 5 hours. The suspension was allowed to settle and filtered. The filter cake, designated as Solid 1, was washed with 6 liters of distilled water and dried 12 hours at 120° C. Solid 1 was analyzed by X-ray fluorescence (XRF) using a Panalytical AN O3 1KW instrument.

500 grams of the dried Solid 1 were then stirred in 3.9 liters of a 2 molar solution of (NH₄)₂SO₄ at 90° C. for 4 hours in order to ion exchange the Na with NH₄. The suspension was allowed to settle and filtered. The filter cake, designated as Solid 2, was washed with 4 liters of distilled water and dried 12 hours at 110° C. The composition was analyzed by XRF. The successful ion exchange is readily apparent by comparison of the % Na₂O in Solids 1 and 2. Solid 2 was then calcined at 650° C. to convert the catalyst to the acidic form. The surface area was measured on a Micromertics ASAP 2420 using the BET method.

TABLE 1

| | Total | Meso | | | |
|---|---|---|---|---|---|
| Analytical | Surface | Surface | | | |
| Results | Area | Area | % SiO₂ | % Al₂O₃ | % Na₂O |
| Standard | 121.20 m²/ | 20.44 m²/ | 77.84 | 16.29 | 0.38 |
| Catalyst | gram | gram | | | |
| Solid 1 | | | 73.62 | 21.66 | 3.09 |
| Solid 2 | 195.80 m²/ | 71.28 m²/ | 71.58 | 23.05 | 0.02 |
| | gram | gram | | | |

Solid 2 was tested in a small scale fluidized bed reactor and compared to the standard catalyst under the same conditions.

TABLE 2

| Test Results | % Oxygen in Oil |
|---|---|
| Standard | 14.5 |
| Catalyst | |
| Solid 2 | 2.4 |

The above experiment demonstrates that formed microspheres of the standard catalyst can be desilicated by comparing the Al₂O₃/SiO₂ ratios of the standard catalyst (Al₂O₃/SiO₂ ratio=0.21) and Solid 2 (Al₂O₃/SiO₂ ratio 0.32). Comparison of the meso surface area of Solid 2 with the standard catalyst is believed to result in an enhanced diffusivity within the microspheres. The test results demonstrate that Solid 2 has improved deoxygenation properties and produces an oil product having a lower oxygen content than the oil product produced by the standard catalyst.

### INCORPORATION BY REFERENCE

Reference is made to U.S. Provisional Patent Application Ser. No. 61/600,148, entitled “CATALYST COMPOSITIONS COMPRISING IN SITU GROWN ZEOLITES ON CLAY MATRIXES EXHIBITING HIERARCHICAL PORE STRUCTURES”, Attorney Docket No. ID 223-228US-PRO, filed on Feb. 17, 2011, to U.S. Provisional Patent Application Ser. No. 61/600,153, entitled “CATALYST COMPOSITION WITH INCREASED BULK ACTIVE SITE ACCESSIBILITY FOR THE CATALYTIC THERMOCONVERSION OF BIOMASS TO LIQUID FUELS AND CHEMICALS”, Attorney Docket No. ID 260US-PRO, filed on Feb. 17, 2011, to U.S. Provisional Patent Application Ser. No. 61/600,160, entitled “CATALYST COMPOSITION COMPRISING MATRIXES AND ZEOLITES WITH HIERARCHICAL PORE STRUCTURES FOR OPTIMUM ACTIVE SITE ACCESSIBILITY FOR USE IN THE CATALYTIC THERMOCONVERSION OF BIOMASS TO LIQUID FUELS AND CHEMICALS”, Attorney Docket No. ID 261US-PRO, filed on Feb. 17, 2011, the entire content of each being hereby incorporated by reference in its entirety. All publications, patents and mentioned herein are hereby incorporated by reference in their entirety as if each individual publication or patent was specifically and individually indicated to be incorporated by reference.

1-51. (canceled)

52. A composition for the conversion of biomass comprising:
a. a catalyst system comprising a zeolite having a high silica to aluminum ratio and a hierarchical pore structure with pores having a size ranging from about 5 to 20 angstrom, a non-zeolitic matrix with a macroporosity from about 100 to about 5,000 angstrom pore size range, and a binder; and
b. a feedstock having a carbon ¹⁴C isotope content of about 107 pMC.

53. The composition of claim 52 wherein the zeolite is MFI, beta zeolite or mixtures thereof.

54. The composition of claim 52 wherein the matrix comprises silica, alumina, silica-alumina, transitional metal oxide or a combination thereof.

55. The composition of claim 52 wherein the feedstock is a particulated biomass, or is a product derived from pyrolysis of biomass.

56. The composition of claim 52 wherein the feedstock is a bio-oil vapor or a bio-oil.

57. A process for upgrading bio-oil vapors, the process comprising heating the bio-oil vapors in presence of the catalyst system, the catalyst system comprising a zeolite having a hierarchical pore structure ranging from 5 to 20 angstrom pore size, a non-zeolitic matrix with a hierarchical pore structure ranging from about 100 to about 5,000 angstrom pore size, and a binder.

58-128. (canceled)

129. A catalyst system comprising in situ crystallized zeolite having a hierarchical pore structure ranging from 20 to 1,000 Angstrom pore size, a non-zeolitic matrix having a hierarchical pore structure ranging from 50 to 5,000 Angstrom pore size.

130. The catalyst system of claim 129 wherein the zeolite is a MFI-type zeolite, a beta-zeolite or mixture thereof.

131. The catalyst system of claim 129 wherein the zeolite is a hydrothermally treated zeolite.

132. The catalyst system of claim 129 wherein the zeolite is a dealuminated zeolite, a desilicated zeolite or dealuminated desilicated zeolite.

133. The catalyst system of claim 129 wherein the zeolite is phosphated, the matrix is phosphated or the zeolite and the matrix are phosphated.

134. The catalyst system of claim 129 wherein the matrix comprises a clay, a modified clay, a clay mixture, a modified clay mixture or combination thereof.

135. The catalyst system of claim 129 further comprising a binder.

136. The catalyst system of claim 135 wherein the binder is silica, alumina or silica alumina.

137. A composition comprising:
a. a catalyst system comprising in situ crystallized zeolites having a hierarchical pore structure ranging from 20 to 1,000 Angstrom pore size into a clay matrix having a hierarchical pore structure ranging from about 50 to about 5,000 angstrom; and
b. a feedstock having a carbon ¹⁴C isotope content of about 107 pMC.

138. The composition of claim 137 wherein the zeolite is a MFI-type zeolite, a beta-zeolite or mixture thereof.

139. The composition of claim 137 wherein the clay is kaolin clay, a modified kaolin clay or mixture thereof.

140. The composition of claim 137 wherein the feedstock is a particulated biomass, or is a product derived from pyrolysis of biomass.

141. The composition of claim 140 wherein the feedstock is a bio-oil vapor or a bio-oil.

142. A process for the catalytic thermolysis of biomass, the process comprising heating the biomass to a conversion temperature in presence of the catalyst system of claim 129.

143. A process for the catalytic upgrading of bio-oil, the process comprising heating the bio-oil in presence of the catalyst system of claim 129.

144-145. (canceled)
